(19) United States
(12) Patent Application Publication
(10) Pub. No.: US 2019/0373030 A1
(43) Pub. Date: Dec. 5, 2019

(54) INTERACTIVE LIVE PERFORMANCE PLATFORM AND METHOD

(71) Applicant: ERA DIGITAL MEDIA CO., LTD., TAIPEI CITY (TW)

(72) Inventor: FU-SHENG CHIU, TAIPEI CITY (TW)

(21) Appl. No.: 15/991,156

(22) Filed: May 29, 2018

(51) Int. Cl. H04L 29/06; H04L 29/08; A63J 99/00

(52) U.S. Cl. CPC H04L 65/4053; A63J 99/00; H04L 67/12

(57) ABSTRACT

An interactive live performance platform allows the audience to adapt a performance in real-time. A flowchart including potential variations in the performance is created. Options indicating variations are sent to devices allowing members to select which variation option they prefer. The selected options are sent to a controller server and the optimal option is determined. The controller server utilizes the determined chosen option to send data to adapt the current live performance in real-time according to the chosen option. This process of sending options to the user devices, the users selecting their desired option sending the selected desired option to the controller server, collecting all the selected desired options returned by all the users, choosing an option from the selected desired options, adapting the live performance according to the chosen option, is repeated until the performance is concluded.

### BACKGROUND OF THE INVENTION

### Field of the Invention

The present invention relates to live performance. More specifically, the present invention discloses a platform and method for providing audience participation to interactively determine aspects of a live performance.

### Description of the Prior Art

In conventional theater actors learn lines of a script for their parts. To present the production the actors recite their individual lines in a predetermined order according to the pre-written script.

While the audience can enjoy the production once, there is little incentive for them to return to watch the production a second time since the script is fixed in a set pattern. Every performance is the same as the previous performances.

As a result, the run of the production is time limited and the potential profits are financially limited.

Therefore, there is need for an efficient method and platform that allows the audience to participate in determining aspects of a live performance and the performers respond accordingly in real-time or near real-time.

### SUMMARY OF THE INVENTION

To achieve these and other advantages and in order to overcome the disadvantages of the conventional method in accordance with the purpose of the invention as embodied and broadly described herein, the present invention provides a platform and method for live performances that allows members of the audience to determine aspects of the live performance which causes the performers to react in appropriate manners according to the audience requests in real-time.

A content creator creates a script for the performance which comprises, for example, actor lines, plots, scenes, and stage direction. Performance personnel such as, for example, director, stage manager, lighting director, producer, etc. create lighting data, lighting control data, audio data, audio control data, visual data, visual control data, performance data, personnel data, and performance options. This performance data is stored on a controller server, a push server, an aggregator server, a content server or a combination of these.

An initial performance process flowchart is created utilizing this performance data indicating an initial flow order of the performance That is, the performance would be performed in this initial order if there is no intervention or adaptation.

The flowchart is then revised to include potential variations in the performance. The variations comprise, for example, alternative endings, additional characters, character development, story arc, genre, song order, visuals, lighting, sound, etc.

Just prior to the start of the performance or after the performance has started, the controller server sends the appropriate first set of options indicating possible variations to the user devices. The audience members review the possible options and select which one they would like to see occur in the performance.

The user device then sends the desired option that the user selected back to the controller server. The aggregator server aggregates all of the returned desired options and determines the most appropriate, the most popular, the least popular, or the highest bid option.

The controller server and the content server utilize the chosen option to send data to adapt the current live performance in real-time or near real-time according to the chosen option.

The controller server send updated performance data appropriate for the chosen option for variation to the performer devices, personnel devices, lighting controller, audio controller, and visual controller.

Therefore, the audience is able to adapt the live performance and have an input on the outcome of how the performance is given.

This process of sending options to the user devices, the users selecting their desired option, sending the selected desired option to the controller server, collecting all the selected desired options returned by all the users, choosing an option from the selected desired options, adapting the live performance according to the chosen option, is repeated until the performance is concluded or the available options have been exhausted.

As a result, the audience is more likely to return to enjoy the live performance more than once since the performance flow is not predetermined and is organic in nature. Thus, the performance is more profitable, production runs are extended, and audience satisfaction is improved.

In an embodiment, audience members purchase the right to vote for an option. For example, the user pays money for each time they select an option.

In an embodiment, audience members make monetary based bids in a live online auction for the right to select an option.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1 is a diagram illustrating an interactive performance platform and method according to an embodiment of the present invention;

FIG. 2 is a flowchart illustrating an interactive performance platform and method according to an embodiment of the present invention; and

FIG. 3 is a flowchart illustrating option determination of an interactive performance platform and method according to an embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

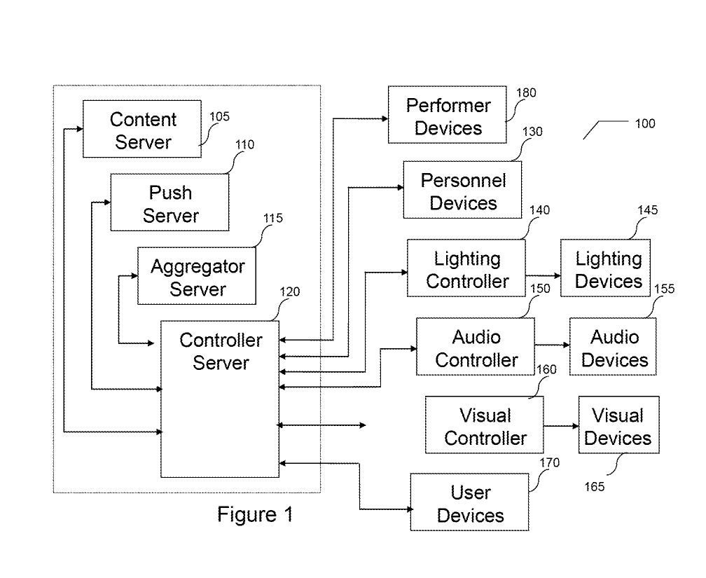

Refer to FIG. 1. The interactive performance platform 100 comprises a controller server 120, a plurality of stage personnel devices 130, a plurality of performer devices 180, and a plurality of user devices 170.

The controller server 120 communicates with a push server 110, an aggregator server 115, and a content server 105. The controller server 120, push server 110, aggregator server 115, and the content server 105 comprise non-volatile memory for storing data utilized in the interactive performance platform 100.

In an embodiment of the present invention the controller server 120, the push server 110, the aggregator server 115, and the content server 105 embodied in a single server.

In an embodiment of the present invention the controller server 120, the push server 110, the aggregator server 115, and the content server 105 comprise a combination of servers.

The push server 110 stores data comprising a plurality of options that indicate choices for altering or adapting the live performance. At appropriate times the push server 110 provides a plurality of options to the controller server 120.

The content server 105 stores various performance data such as script, lighting cues, audio data, audio mixing cues, visual media, timing, and stage directions.

The aggregator server 115 aggregates option data, desired options returned by users, votes, and poll results.

The controller server 120 communicates with the push server 110, the aggregator server 115, and the content server 105.

The controller server 120 interacts with the push server 110 to send a plurality of options to the user devices 170 at appropriate times.

The controller server 120 interacts with the aggregator server 115 to collect selected desired options from the user devices 170.

The controller server 120 interacts with the content server 105 to send performance data to the personnel devices 130 and the performance devices 180. The controller server 120 also interacts with the content server 105 to send lighting data to the lighting controller 140, audio data to the audio controller 150, and visual data to the visual controller 160.

The lighting controller 140 utilizes the lighting data to control the lighting devices 145, for example, lasers, spotlights, beam lights, LEDs, and back lights. The audio controller 150 utilizes the audio data to control the audio devices 155, for example, mixers, amplifiers, speakers, and effect units. The visual controller 160 utilizes the visual data to control the visual devices 165, for example, video mixers, effect units, projectors, televisions, display units, and video players.

The user devices 170 comprise, for example, mobile telephones, remote controls, computers, tablets, earphones, or headsets and are wirelessly connected to the controller server 120. The users or audience members utilize the user devices 170 to select a desired option from the plurality of options sent by the controller server 120 and the push server 110.

The personnel devices 130 comprise, for example, mobile telephones, remote controls, computers, tablets, earphones, or headsets and are wirelessly connected to the controller server 120. The performance personnel or stage personnel utilize the personnel devices 130 to receive performance data such as, for example, stage instructions from the controller server 120. The performance personnel comprises, for example, the stage manager, prop manager, conductor, or director.

The performer devices 180 comprise, for example, mobile telephones, remote controls, computers, tablets, earphones, or headsets and are wirelessly connected to the controller server 120. The performers utilize the performer devices 180 to receive performance data such as, for example, actor lines, prompts, or acting directions from the controller server 120. The performers comprise, for example, actors, musicians, vocalists, dancers, or magicians.

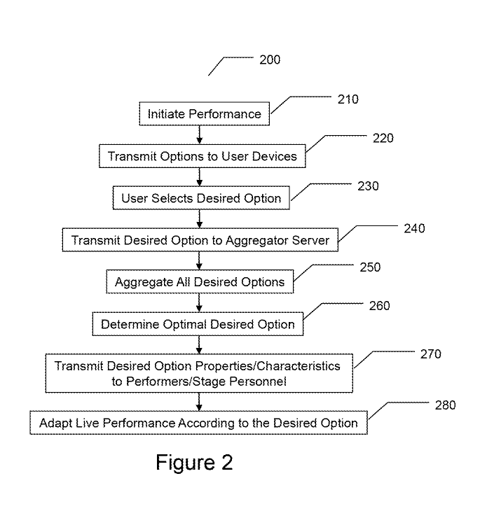

Refer to FIG. 2. The interactive performance method 200 begins in Step 210 by initiating the performance. Once the performance has begun, at an appropriate time in the performance flow plan a plurality of options are sent to each of the users via their individual user device in Step 220.

In Step 230 each user reviews the available options on their user device and each selects the option they desire to be enacted by the performers/stage personnel. The selected option desired by the user is sent via the user's user device to the controller server in Step 240.

In Step 250, all the selected options returned by the user devices are aggregated by the controller server and the aggregator server. If a user does not select one of the available options, no desired option is returned by the user device. Alternatively, if a user does not select one of the available options, a no option selected indication is sent by the user device to the controller server.

Next the optimal desired option is determined by the controller server in Step 260. In an embodiment the optimal desired option is the most popular option selected by the users. In an embodiment the optimal desired option is the least popular option selected by the users. In an embodiment the optimal desired option is selected weighting the most popular option selected by the users with input from the stage personnel or performers.

In Step 270 the properties and characteristics of the optimal desired option are sent to the performance devices of the performers and/or the personnel devices of the stage personnel.

In Step 280 the live performance is adapted according to the optimal desired option.

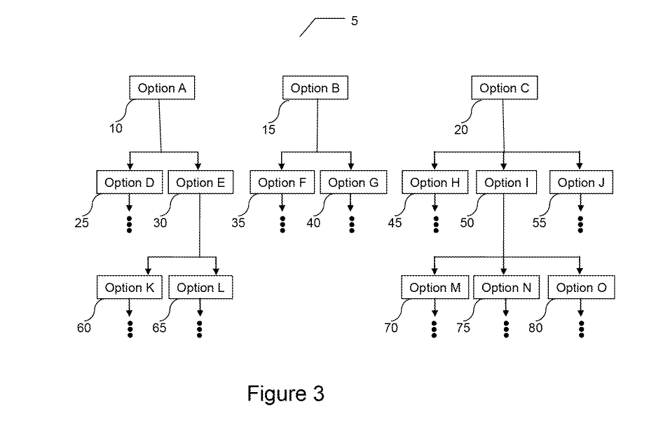

Refer to FIG. 3. The option determination flow 5 of the interactive performance platform and method comprises presenting the users with a plurality of options (10, 15, 20). In this example, the first level options are Option A 10, Option B 15, and Option C 20. These options are sent to the user device of each user.

Each user reviews the available options and selects one of the options as their desired option that they would like to have the performance perform. The user device sends an indication of the selected option to the controller server.

At an appropriate time, the controller server sends a plurality of second level options to the user device of each user. The plurality of second level options is determined by what desired option was chosen by the aggregator server or controller server in the previous option poll. For example, if the previously chosen option was Option A 10, then the users are presented with a choice of Option D 25 and Option E 30. Or for example, if the previously chosen option was Option C 20, then the users are presented with a choice of Option H 45, Option I 50, and Option J 55.

Each user then reviews the newly available options and selects one of the options as their desired option that they would like to have the performance perform. The user device sends an indication of the selected option from the second level set of options to the controller server.

At the next an appropriate time, the controller server sends a plurality of third level options to the user device of each user. The plurality of third level options is determined by what desired option was chosen by the aggregator server or controller server in the previous option poll. For example, if the previously chosen option was Option E 30 then the users are presented with a choice of Option K 60 and Option L 65.

This process of sending options to the user devices, the users selecting their desired option, sending the selected desired option to the controller server, collecting all the selected desired options returned by all the users, choosing an option from the selected desired options, adapting the live performance according to the chosen option, is repeated until the performance is concluded or the available options have been exhausted.

In an embodiment of the present invention the commands, instructions, directions, requests, questions, and responses are auto-detected by the controller server. The controller server then acts to respond accordingly to the keywords, commands, or phrases. As a result, the controller server can rapidly respond to and alter the performance based on the detected keywords, commands, or phrases.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. An interactive performance platform for a live performance comprising:
a content server comprising performance data;
a push server comprising option data, the option data indicating characteristics affecting the live performance;
an aggregator server for aggregating desired options selected by users;
a controller server communicating with the content server, the push server, and the aggregator server;
a lighting controller for receiving lighting data from the controller server, the lighting controller utilizing the lighting data to control a plurality of lighting devices, the lighting devices emitting light;
an audio controller for receiving audio data from the controller server, the audio controller utilizing the audio data to control a plurality of audio devices, the audio devices emitting sound;
a visual controller for receiving visual data from the controller server, the visual controller utilizing the visual data to control a plurality of visual devices, the visual devices displaying visual patterns;
a plurality of user devices for receiving options from the controller server and for sending selected desired options to the controller server;
a plurality of performer devices for receiving performance data from the controller server; and
a plurality of personnel devices for receiving performance data from the controller server.

2. The interactive performance platform for a live performance of claim 1, wherein the controller server, the content server, the push server, and the aggregator server are embodied in a single server.

3. The interactive performance platform for a live performance of claim 1, wherein users purchase each option selection.

4. The interactive performance platform for a live performance of claim 1, wherein users are allowed to purchase additional option selection votes for an option poll.

5. The interactive performance platform for a live performance of claim 1, wherein the user devices, the personnel devices, and the performer devices comprise mobile telephones, remote controls, computers, tablets, earphones, headsets, or a combination of mobile telephones, remote controls, computers, tablets, earphones, and headsets.

6. The interactive performance platform for a live performance of claim 1, wherein the user devices, the personnel devices, and the performer devices are wirelessly connected to the controller server.

7. The interactive performance platform for a live performance of claim 1, wherein users utilize the user devices to select a desired option from options sent by the controller server and the push server.

8. The interactive performance platform for a live performance of claim 1, wherein performance personnel utilize the personnel devices to receive performance data from the controller server.

9. The interactive performance platform for a live performance of claim 1, wherein performers utilize the performer devices to receive performance data from the controller server.

10. An interactive performance platform for a live performance comprising:
a controller server comprising:
a content server comprising performance data;
a push server comprising option data, the option data indicating characteristics affecting the live performance;
an aggregator server for aggregating desired options selected by users;
a lighting controller for receiving lighting data from the controller server, the lighting controller utilizing the lighting data to control a plurality of lighting devices, the lighting devices emitting light;
an audio controller for receiving audio data from the controller server, the audio controller utilizing the audio data to control a plurality of audio devices, the audio devices emitting sound;
a visual controller for receiving visual data from the controller server, the visual controller utilizing the visual data to control a plurality of visual devices, the visual devices displaying visual patterns;
a plurality of user devices wirelessly connected to the controller server for receiving options from the controller server and for sending selected desired options to the controller server;
a plurality of performer devices wirelessly connected to the controller server for receiving performance data from the controller server; and
a plurality of personnel devices wirelessly connected to the controller server for receiving performance data from the controller server.

11. The interactive performance platform for a live performance of claim 10, wherein users purchase each option selection.

12. The interactive performance platform for a live performance of claim 10, wherein users are allowed to purchase additional option selection votes for an option poll.

13. The interactive performance platform for a live performance of claim 10, wherein the user devices, the personnel devices, and the performer devices comprise mobile telephones, remote controls, computers, tablets, earphones, headsets, or a combination of mobile telephones, remote controls, computers, tablets, earphones, and headsets.

14. The interactive performance platform for a live performance of claim 10, wherein users utilize the user devices to select a desired option from options sent by the controller server and the push server.

15. The interactive performance platform for a live performance of claim 10, wherein performance personnel utilize the personnel devices to receive performance data from the controller server.

16. The interactive performance platform for a live performance of claim 10, wherein performers utilize the performer devices to receive performance data from the controller server.
